(19) United States
(12) Patent Application Publication
(10) Pub. No.: US 2011/0122812 A1
(43) Pub. Date: May 26, 2011

(54) SEAMLESS SERVICE METHOD CONTROLLED BY USER TERMINAL

(75) Inventors: Byung Jang Jeong, Daejeon (KR); Hyun Kyu Chung, Daejeon (KR); Seong Keun Oh, Gyeonggi-do (KR); Jae-Hyun Kim, Gyeonggi-do (KR); Hyun-Jin Lee, Gyeonggi-do (KR)

(73) Assignees: Electronics and Telecommunications Research Institute, Daejeon (KR); Ajou University Industry - Academic Cooperation Foundation, Gyeonggi-do (KR)

(21) Appl. No.: 12/808,667

(22) PCT Filed: Dec. 18, 2008
(86) PCT No.: PCT/KR2008/007503

§ 371 Date: Jun. 16, 2010

(30) Foreign Application Priority Data
Dec. 18, 2007 (KR) 10-2007-0133629
Aug. 29, 2008 (KR) 10-2008-0085223

(51) Int. Cl. H04W 40/00

(52) U.S. Cl. 370/328

(57) ABSTRACT

Provided are a seamless service method controlled by a user terminal, the method including: storing radio access technology (RAT) information and service flow information associated with a connecting radio access network (RAN); when a new link is detected, storing RAT information associated with the new link; verifying whether a new RAN satisfying a handover initiation criterion exists; when the new RAN exists, attempting a link connection with the new RAN; being assigned with an Internet Protocol (IP) to be used in the new RAN; setting up a handover service flow using the new RAN; and receiving a service via multiple paths using a connecting service flow and the handover service flow. Through this, it is possible to provide the seamless QoS even while the handover is being performed.

### TECHNICAL FIELD

The present invention relates to a seamless service method controlled by a user terminal, and more particularly, to a user terminal and method for providing a seamless service using a multiple path transmission based on a radio access network (RAN) preference of a user, Quality of Service (QoS) parameters of an upper layer, a cost, and the like, when changing a RAN according to a movement of the user.

### BACKGROUND ART

An existing mobility securing technology between heterogeneous networks is a technology that enables a user terminal to interoperate with a radio access network (RAN) and thereby obtaining mobility. The technology has a complex procedure and has an overhead of a large number of signaling. Also, a service disconnection caused by the signaling generally functioned as a main factor to deteriorate a Quality of Service (QoS) in view of a user side and also required a very complex network management technology. When connecting a RAN with a network element or a network technology such as Common Radio Resource management (CRRM) in order to improve a handover function, a new standard was required to add a new radio access technology (RAT) and an additional facility extension was also required.

A mobile Internet Protocol (MIP) was developed in order to provide IP to a mobile node (MN) that provides a mobility. When an existing IP protocol provides the mobility, an IP address may be changed every time an access point (AP) is changed according to a movement of the MN. In this case, there is required a scheme of performing routing using the changed IP address to thereby provide a consistent transmission. However, in order to continuously maintain a connection of a Transmission Control Protocol (TCP)/User Datagram Protocol (UDP) that is connected before the movement of the MN, the same IP address needs to be maintained. The MIP uses two different IP address in order to solve such two conflicting problems. A home address denotes an IP address that the MN consistently uses while a connection from the home agent (HA) is being maintained. A Care of Address (CoA) denotes an IP address that the MN is newly assigned from a foreign agent (FA) every time the AP changes according to movement of the MN. The MIP includes an agent discovery process, a registration process, and a data transfer process. When the AP changes according to movement of the MN, the MIP may tunnel a packet to the AP of the MN using a temporary IP address and transmit the tunneled packet using a permanent IP address and thereby solving the above conflicting problems. When using the MIP, it is possible to provide the mobility to the MN. However, a signaling process may be too complex and the existing IP needs to be corrected. Also, since handover is performed separately from a layer 2 (L2) handover, a handover latency may be long, which results in causing many problems when providing the seamless service. Media Independent Handover (MIH) is targeted to provide information associated with a radio link and information associated with a network that is required to perform optimized handover between heterogeneous networks. Independently from a network technology, the MIH standardizes a technology for providing the seamless handover between the heterogeneous networks. The MIH generally provides three services, for example, an event service, a command service, and an information service. The event service denotes a service that transfers event information to an upper layer when an event where a link state is changed occurs. The command service denotes a service that transfers a command to change a setup of a link in the upper layer, based on the event information. The information service denotes a service that provides information required for the event/command service. However, in order to provide the handover between the heterogeneous networks using the MIH, there is a need for a new network element and an additional signaling procedure.

Also, there are a scheme of using a multi homing for supporting a seamless service in a layer of at least L3, a stream control transmission protocol (SCTP) for supporting a dynamic address allocation, and the MIH for information transfer of a lower layer, and a scheme of supporting a connection of multiple services using a reINVITE of a Session Initiation Protocol (SIP). However, the above schemes support only actual multiple path transmission since a single path causes an actual user traffic. Accordingly, when a path change is required via a backbone network, a latency cannot be predicted and thus it may be very difficult to provide the seamless service.

In order to overcome a problem found in a technology that is used to provide the seamless service in the lower layer and a problem found in a technology that is used to provide the seamless service in the upper layer, there is a need for a user terminal and a method for providing the seamless service in which a user terminal can self-directly search for a RAN available for service connection and connect multiple service flows with respect to the same service based on a signal quality, a QoS parameter, a user's RAN preference, and a service cost and thereby providing the seamless service.

### DISCLOSURE OF INVENTION

### Technical Goals

An aspect of the present invention provides a user terminal device and a method that can reduce help of a network in an upper layer and also can maintain an end-to-end Quality of Service (QoS) when a user terminal moves, which is different from an existing mobility securing technology.

Another aspect of the present invention also provides a seamless service method controlled by a user terminal that, when changing a radio access network (RAN) according to a user movement, can provide a seamless service using a multiple path transmission based on a user's RAN preference, an upper layer QoS parameter, a cost, and the like.

The present invention is not limited to the above purposes and other purposes not described herein will be apparent to those of skill in the art from the following description.

### Technical Solutions

According to an aspect of the present invention, there is provided a method of providing a seamless service, wherein a user terminal self-directly determines a connection.

According to another aspect of the present invention, there is provided a system architecture for providing a seamless service, wherein a layer for providing a mobility to an upper layer greater than a transport layer exists so that a user terminal may self-directly provide the seamless service.

According to still another aspect of the present invention, there is provided a user terminal for self-directly determining a connection to provide a seamless service.

Details of other embodiments are included in the following detailed description and the accompanying drawings.

Advantages and aspects of the invention, and the method of achieving them will become explicit by referring to embodiments that are described in detail with reference to the accompanying drawings. However, the invention is not limited thereto and may be variously embodied. The embodiments are provided below in order to make the disclosure of the invention be perfect and to inform those of skills in the art about the scope of the invention which is defined by the claims and their equivalents. Like reference numerals refer to the like elements throughout.

### Advantageous Effect

According to embodiments of the present invention, there may be provided a seamless service method controlled by a user terminal, the method including: storing radio access technology (RAT) information and service flow information associated with a connecting radio access network (RAN); when a new link is detected, storing RAT information associated with the new link; verifying whether a new RAN satisfying a handover initiation criterion exists; when the new RAN exists, attempting a link connection with the new RAN; being assigned with an Internet Protocol (IP) to be used in the new RAN; setting up a handover service flow using the new RAN; and receiving a service via multiple paths using a connecting service flow and the handover service flow. Through this, it is possible to provide seamless Quality of Service (QoS) using multiple paths.

### BRIEF DESCRIPTION OF DRAWINGS

FIG. 1 illustrates a system architecture of a user terminal for providing a seamless service according to an embodiment of the present invention;

FIG. 2 is a block diagram illustrating a configuration of a handover decision module in the system architecture of the user terminal shown in FIG. 1;

FIG. 3 illustrates a handover concept of setting up multiple paths every time a user terminal moves and thereby maintaining a QoS according to an embodiment of the present invention; and

FIG. 4 is a flowchart illustrating a method of maintaining a QoS even when a user terminal performs handover according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention will be described in detail with reference to the accompanying drawings. When it is determined detailed description related to a related known function or configuration they may make the purpose of the present invention unnecessarily ambiguous in describing the present invention, the detailed description will be omitted here.

Proposed is a seamless service method controlled by a user terminal that can maintain a Quality of Service (QoS) using a multiple path transmission by considering a user preference for a radio access network (RAN), an upper layer QoS parameter, a cost, and the like when changing the RAN according to a movement of a user terminal.

Prior to describing the present invention, terms used herein will be defined as follows. The term “access technology” denotes an interface technology that connects a user terminal and a wireless network or a wired network. In particular, a radio access technology (RAT) denotes an air interface technology that enables the user terminal to be connected to a base station or an access point (AP). Examples of the RAT may include a cellular access technology defined in a 3rd Generation Partnership Project (3GPP), 3GPP2, and the like, and a Wireless Local Area Network (WLAN) technology defined in an Institute of Electrical and Electronics Engineers (IEEE) 802.11 standard, a Mobile Wireless Metropolitan Area Network (MAN) technology defined in an IEEE 802.16e standard, a Personal Area Network (PAN) technology defined in an IEEE 802.15 standard, and the like. IEEE 802.3 Ethernet may be a representative example of the wired access technology.

The term “seamless service” used herein denotes a service that enables an application service provided for a user to satisfy a required QoS even when an accessing base station or a RAN of the user changes. For example, in the case of a voice service, when the voice service can satisfy a latency request criterion of within about 150 msec, 3GPP defines the voice service as the seamless service.

The term “service flow” used herein denotes a flow of a service packet that is defined between a user terminal and a service server or another user terminal in order to provide the user with a service requested by the user. The service flow is defined by an IP address and a port number that are used in a transmitting/receiving apparatus.

The term “handover predicted RAN” used herein denotes a network in which a registration process is performed in such a manner that a user terminal searches for an accessible RAN. When a plurality of handover predicted RANs exists, a RAN selection process may be performed in order to select a handover performing RAN.

The term “handover performing RAN” used herein denotes a RAN that satisfies a RAN selection criterion among registered handover predicted RANs. The user terminal may set up a service flow via the handover performing RAN.

The term “handover service flow” denotes a service flow that is set up via the handover performing RAN and a current RAN in order to provide the seamless service while the user terminal changes the RAN. Although the handover service flow provides the same service flow, a transmission IP or a reception IP may change. For example, in the case of a service flow that has the same port number and the same reception IP but the different transmission IP while changing the RAN, this service flow can be the handover service flow.

The term “received signal quality” may include a signal-to-noise ratio (SNR), a signal-to-interference noise ratio (SINR), a bit error rate (BER), and the like. A RAN load may include the length of a queue remaining in a base station, the length of a stored queue, and an amount of remaining resources, available resources, and the like. QoS parameters may include a packet transmission latency, a processing amount, a change amount in a packet latency, an error rate, and the like.

The term “radio access network (RAN)” may be defined as a network that connects a user terminal and a back-bone network using a wireless/wired access technology. For example, in 3GPP, a network including a node-B and a radio network controller (RNC) as network elements may be defined as the RAN. The RAN may be connected to the backbone network via a core network such as a Serving GPRS Support Node (SGSN)/Gateway GPRS Support Node (GGSN).

The term “heterogeneous network” may correspond to a case where a network has a different access technology or operator from a network that a user terminal connectable to multiple RANs using multiple RATs is currently receiving a service from. For example, when a current RAN is a WLAN, remaining available RANs excluding the WRAN may be the heterogeneous network.

The term “user terminal” defined herein may denote all the terminal devices that can perform radio communications. For example, the user terminal may include a user terminal such as a cellular phone, a personal digital assistant (PDA), and a notebook, a desktop personal computer (PC) including a wireless LAN, and the like. For ease of description, the user terminal may be expressed as a mobile terminal.

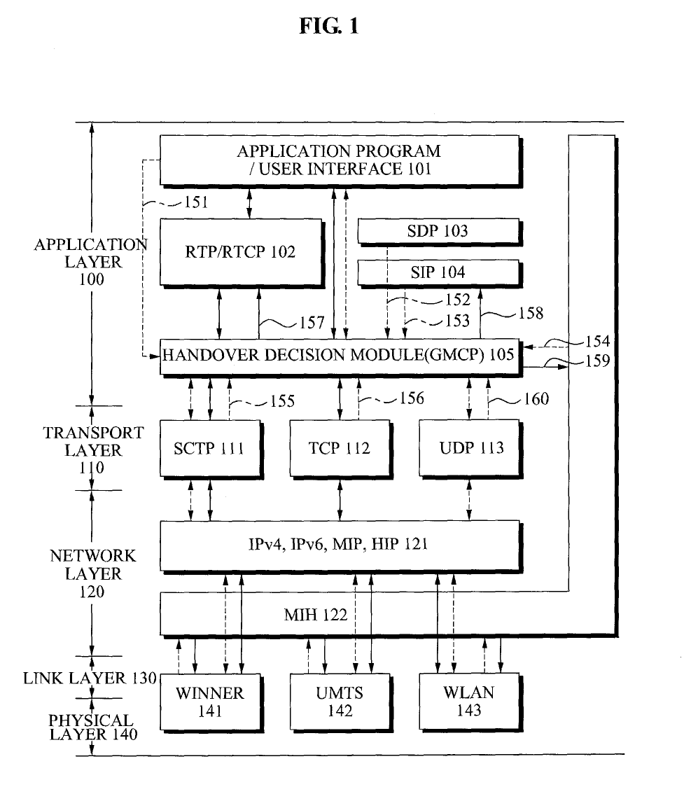

Hereinafter, a system architecture of a user terminal maintaining a QoS via a multiple path transmission in handover will be described with reference to FIG. 1. FIG. 1 illustrates the system architecture of the user terminal of providing a seamless service according to an embodiment of the present invention.

Referring to FIG. 1, the system architecture includes an application layer 100, a transport layer 110, a network layer 120, a link layer 130, and a physical layer 140.

In the application layer 100, an application program/user interface 101 may provide an interface that enables a user to set up information 151 regarding a user name, an email address, a telephone number, and a preferred RAN. When performing handover between heterogeneous networks, the application program/user interface 101 may provide information associated with the preferred RAN to a handover decision module 105.

A Real-time Transport Protocol (RTP)/Real-time Control Protocol (RTCP) 102 may receive a time stamp 157 about UDP traffic. A combination of service flows using RTP/RTCP may be performed in the handover decision module 105.

A session Initiation Protocol (SIP) 104 is in charge of invite/approve/disconnect of a user service flow. The SIP 104 may provide service flow information 150 to the handover decision module 105. Through this, the SIP 104 may participate in setting up a handover service flow.

A Session Description Protocol (SDP) 103 may store media information associated with the service flow, information associated with a transmitting/receiving terminal, and time information associated with the service flow. In response to a request for service flow information from the handover decision module 105, the SDP 103 may provide the service flow information 152.

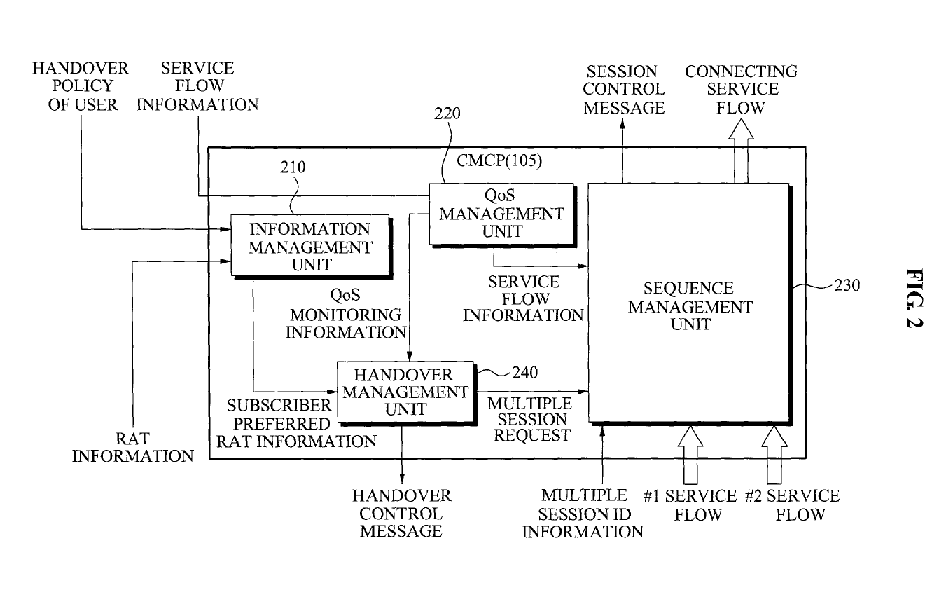

The handover decision module 105, which is also referred to as a Generalized Mobility Control Protocol (GMCP), may manage information associated with the service flow set up by the user terminal, handover preference information of the user, available RAT information. Also, the handover decision module 105 may manage resources required by the service flow, using the service flow information 152 and 153. The handover decision module 105 may control a handover initiation, a RAN selection, and a handover completion based on a QoS parameter requested by the service flow, a user's RAN preference, a service cost, and the like. While the handover is being performed, the handover decision module 105 may perform setup, recognition, combination of the handover service flow using multiple paths. The handover decision module 105 may be further described in detail with reference to FIG. 2.

In the transport layer 110, a Transport Control Protocol (TCP) 112 may perform a retransmission function in order to provide a reliability of the service flow and may also perform an end-to-end confusion control in order to relieve a network confusion. According to an aspect of the present invention, when the handover service flow, transmitted via multiple paths while the handover is being performed, uses the TCP 112, the TCP 112 may provide the handover decision module 105 with service flow information 156 such as a port number, a sequence number, and the like.

A UDP 113 may be used to define a real-time service flow and may not perform the retransmission function or the confusion control. According to an aspect of the present invention, when the handover service flow, transmitted via the multiple paths while the handover is being performed, uses only the UDP 113, the UDP 113 may provide the handover decision module 105 with service flow information 160 such as a port number.

A Stream Control Transmission Protocol (SCTP) 111 may support both a real-time service flow and a non-real time service flow, use a multiple path setup technology in order to improve a reliability of a real-time service flow, and provide partial multi-homing using the multiple path setup technology and a dynamic address re-setup technology.

In the network layer 120, an Internet Protocol (IP) 121 may be used to define the service flow and may include Internet Protocol version 4 (IPv4), IPv6, MIP, HIP, and the like. IPv4 is a most widely used Internet protocol and uses a 32-bit address and may be used to define the service flow. When performing handover between heterogeneous networks, the service flow may be disconnected due to change of the IP address. This disconnection problem may be solved using a MIP technology.

A Media Independent Handover (MIH) 122 may denote an apparatus that can improve a handover efficiency using a layer 2 (L2) trigger in order to provide independent handover to a RAN when performing handover between heterogeneous networks. The MIH 122 may provide the handover decision module 105 with information 154 associated with a connecting RAT and a found RAT, and receive, from the handover decision module 105, a control message 159 for handover initiation, selected RAT information, and handover completion and thereby performing the handover.

The link layer 130 and the physical layer 140 of FIG. 1 are the same or similar to a conventional art and thus detailed descriptions related thereto will be omitted here.

FIG. 2 is a block diagram illustrating a configuration of the handover decision module 105 in the system architecture of the user terminal shown in FIG. 1. Referring to FIG. 2, the handover decision module (GMCP) 105 includes an information management unit 210, a QoS management unit 220, a sequence management unit 230, and a handover management unit 240.

The information management unit 210 is a device that functions to maintain and manage service flow information and thus may performing a service flow information management, a handover policy management, and a RAT information management. More specifically, the service flow information management denotes storing and managing media information, service flow information, and service flow time stamp information. In this instance, the media information may include, for example, kinds of media (audio, video, etc.) provided via SDP/SIP, transmission protocol information (SCTP, TCP, UDP), and a media format (H.261 video, MPEG video, etc). The service flow information may include, for example, a transmitting/receiving IP address and a port number. The service flow time stamp information may include, for example, a connection starting time of the service flow, a scheduled termination time thereof, and a current maintaining time thereof. The handover policy management denotes managing user access information of an available RAN and user preference RAN information from the user interface. The RAT information management denotes storing information associated with an available RAN of the user terminal, and managing information regarding an available transmission rate for each RAT, a received signal quality, available QoS information, a service cost, a network load, and the like.

The QoS management unit 220 is a device that functions to determine whether a QoS of the service flow is satisfied. The QoS management unit 220 may perform a service flow request resource management and a service flow request QoS parameter management. More specifically, the service flow request resource management denotes managing radio requires required to satisfy the QoS of the service flow set up in a currently connecting RAN, based on the service flow information that is provided via the SDP 103 or the SIP 104 of FIG. 1. In this instance, the service flow request resource may be calculated based on a generation characteristic of a service flow packet, session information defined when setting up the service flow, and a usage protocol. The service flow request QoS management denotes calculating a QoS parameter associated with the currently setup service flow by referring to a request QoS parameter table for each service class when there is no session information associated with the service flow.

The sequence management unit 230 is a device that functions to combine, into a single service flow, the same service flow transmitted via multiple paths during the handover. The sequence management unit 230 may perform a handover service flow setup management, a multiple path service flow combining management, a TCP service flow sequence management, and a UDP service flow time stamp management.

More specifically, the handover service flow setup management of the sequence management unit 230 denotes performing a process of setting up a handover service flow while the user terminal is performing the handover, changing an IP address assigned from a handover decision RAN to a transmitting or receiving IP address when using SIP, an IP address assigned in a handover decision RAN may be changed to a transmitting or receiving changing an IP address, and transmitting an invite message using QoS information of the service flow stored in SDP.

The multiple path service combining management of the sequence management unit 230 denotes performing a function of recognizing the setup handover service flow while the user terminal is performing the handover, and performing a function of recognizing the handover service flow based on service flow information, stored during the service flow information management, when an IP packet with the same port number and the same transmitting IP address but a different receiving IP address is transmitted while the user terminal is changing a RAN.

The TCP service flow sequence management of the sequence management unit 230 denotes performing a function of combining service flows in order to provide an upper layer transparency when the setup handover service flow uses TCP while the user terminal is performing the handover, and comparing sequence numbers based on packet information of handover service flows to thereby selectively transfer the comparison result to the upper layer based on a packet loss and a packet arrival time.

The UDP service flow time stamp management of the sequence management unit 230 denotes performing a function of combining service flows in order to provide the upper layer transparency when the setup handover service flow uses UDP while the user terminal is performing the handover, and selectively transferring packets to the upper layer based on time stamp information when the handover service flow uses UDP/RTP, and comparing packet information of the handover service flow to thereby selectively transfer the comparison result when the handover service flow uses UDP.

The handover management unit 240 is a device that functions to initiate handover, select an appropriate RAT, and complete the handover. The handover management unit 240 may perform a handover initiation control, a handover performing RAN selection, and a handover completion control.

More specifically, the handover initiation control of the handover management unit 240 denotes setting up a connection with a base station of a newly found RAN based on a received signal quality of a currently connecting RAN among newly discovered RANs, a satisfaction level regarding a QoS parameter required by the service flow, a user's RAN preference, and a service cost.

The handover performing RAN selection of the handover management unit 240 denotes a process of selecting a handover performing RAN to set up the handover service flow when a plurality of handover predicted RANs exists. In this process, the handover performing RAN may be selected based on a received signal quality of the handover predicted RANs, a RAN load, a user's RAN preference, a service cost, and the like. When the handover performing RAN is selected, a registration process may be performed in order to be assigned with a new IP address. Also, when the handover performing RAN is selected, a request for setup of the handover service flow may be transmitted to the MIH 122.

The handover completion control of the handover management unit 240 denotes disconnecting the connection of the service flow based on a received signal quality of RANs where the handover service flow is set up among handover performing RANs, a RAN load, a QoS satisfaction level of the handover service flow, a user's RAN preference, and a service cost.

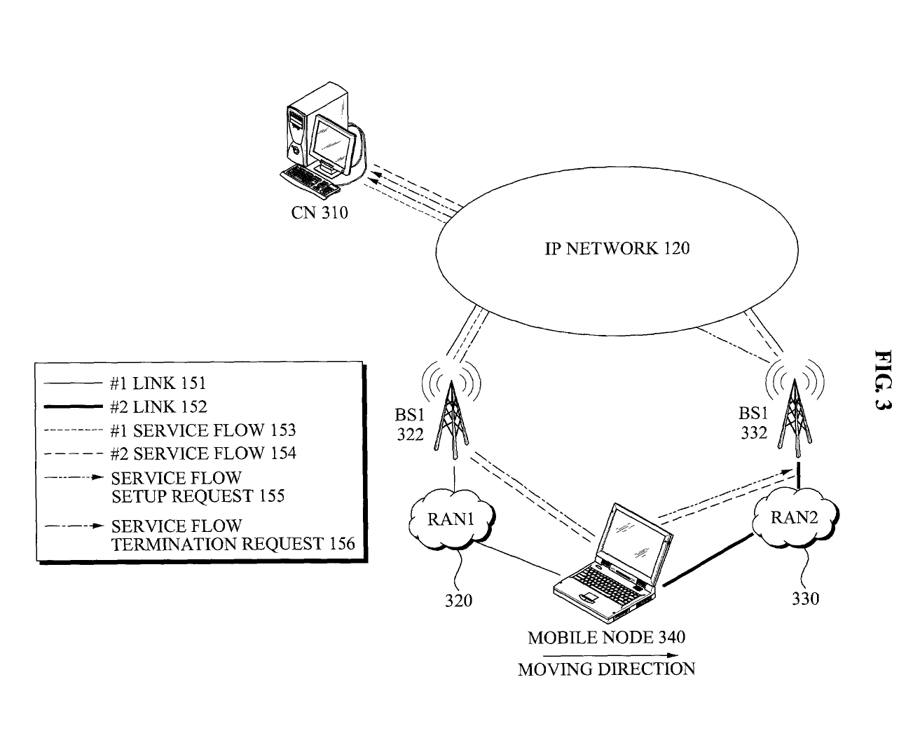

FIG. 3 illustrates a handover concept of setting up multiple paths every time a user terminal moves and thereby maintaining a QoS according to an embodiment of the present invention.

Referring to FIG. 3, in order to set up a RAN (1) 320, a user terminal, that is, a mobile node 340 may perform a process of setting up a connection with a base station (BS1) 322 and perform a registration process of being assigned with an IP address to be used via a RAT of the RAN (1) 320 and thereby connecting a first link 151.

Next, in order to provide a user request service, the mobile node 340 may perform a first service flow 153 via the RAN (1) 320. In this instance, the handover management unit 240 of the handover decision module 105 may request the MIH 122 to periodically or non-periodically search for a new RAN based on user preference RAN information. When a request for periodical RAN search is received, the MIH 122 may activate an interface of an accessible RAN to thereby periodically search for the new RAN. When a request for non-periodical RAN search is received, the MIH 122 may search for the new RAN based on information such as a signal quality of a RAN connected with the service flow, a RAN load, a QoS satisfaction level, a user's movement speed, and the like. When the new RAN is found, the handover management unit 240 may store information associated with the new RAN.

In the user terminal 340, when a RAN satisfying a handover initiation criterion exists among RANs stored in a handover predicted RAN database, the handover management unit 240 may command the MIH 122 of a connection with the RAN and perform a handover initiation process using an RAT of a RAN (2) 330 corresponding to the handover predicted RAN to thereby set up a connection with a second link 152 which is a new link.

The handover initiation criterion may include a portion or all of a received signal quality of a current RAN, a RAN load, a QoS level of the service flow, a user movement speed, a user's RAN preference, and a service cost.

Hereinafter, a criterion for commanding a connection with a handover predicted RAN will be described. First, in the case of considering the received signal quality of the current RAN (1) 320, when the received signal quality of the current RAN (1) 320 is reduced to be less than or equal to a threshold, or maintained to be less than or equal to the threshold for a predetermined period of time, the handover management unit 240 may command a connection of the second link 152 with the RAN (2) 330 stored in the handover predicted RAN database.

Second, in the case of considering a packet latency among QoS parameters of the service flow, when a packet latency of the first service flow 153 is greater than a packet latency required by the service flow, or maintained to be greater than the packet latency required by the service flow for a predetermined period of time, the handover management unit 240 may command a connection of the second link 152 with a RAN stored in the handover predicted RAN database.

Third, in the case of considering a processing amount among QoS parameters of the service flow, when a processing amount of the first service flow 153 is less than a processing amount required by the service flow, or maintained to be less than the processing amount required by the service flow for a predetermined period of time, the handover management unit 240 may command the connection of the second link 152 with the RAN stored in the handover predicted RAN database.

Fourth, in the case of considering a latency change amount among QoS parameters of the service flow, when a latency change amount of the first service flow 153 is greater than a latency change amount required by the service flow, or maintained to be greater than the latency change amount required by the service flow for the predetermined period of time, the handover management unit 240 may command the connection of the second link 152 with the RAN stored in the handover predicted RAN database.

Fifth, in the case of considering an error rate among QoS parameters of the service flow, when an error rate of the first service flow 153 is greater than an error rate required by the service flow or maintained to be greater than the error rate required by the service flow for the predetermined period of time, the handover management unit 240 may command the connection of the second link 152 with the RAN stored in the handover predicted RAN database.

Seventh, in the case of considering the user's RAN preference, when the newly found RAN (2) 330 has a priority in the RAN preference set up by the user, the handover management unit 240 may command the connection of the second link 152 with the RAN stored in the handover predicted RAN database.

Eight, in the case of considering the service cost, when a transmission cost per unit bit of the newly found RAN (2) 330 is less than a transmission cost per unit bit of the current RAN (1) 320, the handover management unit 240 may command the connection of the second link 152 with the RAN stored in the handover predicted RAN database.

Next, the handover management unit 240 may select a handover performing RAN and then perform a handover service flow setup request 155 using the selected handover performing RAN. When a plurality of RANs among the found RANs satisfies the handover initiation criterion, the handover management unit 240 may select a handover performing RAN that satisfies a handover selection criterion. The handover selection criterion may include a portion or all of a received signal quality, a RAN load, a user's RAN preference, and a service cost.

Hereinafter, a criterion of selecting the handover performing RAN from the plurality of RANs satisfying the handover initiation criterion will be described. First, in the case of considering the received signal quality, the handover management unit 240 may select, from newly registered handover predicted RANs, a RAN with the best received signal quality or a RAN with the best average signal received quality during a predetermined period of time.

Second, in the case of considering the RAN load, the handover management unit 240 may select, from the newly registered handover predicted RANs, a RAN with the least RAN load or a RAN with the least average RAN for a predetermined period of time.

Third, in the case of considering the user's RAN preference, the handover management unit 240 may select, from the newly registered handover predicted RANs, a RAN with the highest user's RAN preference.

Fourth, in the case of considering the service cost, the handover management unit 240 may select, from the newly registered handover predicted RANs, a RAN with the lowest service cost.

The user terminal 340 may combine, into a single service flow, the service flow 153 via an existing RAN and the handover service flow 154 via a handover selecting RAN using the sequence management unit 230. In this instance, a terminal or a server that receives a handover service flow setup request may change an IP address to a transmitting or receiving IP address to thereby generate a handover service flow and transmit the generated handover service flow.

When the handover service flow 154 is set up, the handover management unit 240 may disconnect a connection of the service flow 153 based on a handover completion criterion. In this instance, the handover completion criterion may include a received signal quality of each of RANs connected with the service flow, a RAN load, a QoS satisfaction level of the service flow, a user's RAN preference, and a service cost.

Hereinafter, the handover completion criterion for disconnecting the connection of the service flow will be described. First, in the case of considering the received signal quality of the handover performing RAN as the handover completion criterion, the handover management unit 240 may disconnect a connection of a RAN with the received signal quality by the threshold less than the RAN with the best received signal quality, or may disconnect a connection of a RAN that maintains the received signal quality by the threshold less than the RAN with the best received signal for a predetermined period of time.

Second, in the case of considering the RAN load of the handover performing RAN as the handover completion criterion, the handover management unit 240 may disconnect a connection of a RAN with the RAN load by the threshold greater than the RAN with the least RAN load, or may disconnect a RAN that maintains the RAN load by the threshold greater than the RAN with the least RAN load for the predetermined period of time.

Third, in the case of considering a latency among QoS parameters of the service flow as the handover completion criterion, the handover management unit 240 may disconnect a connection of a service flow connected via a RAN that does not satisfy a latency required by the service flow for the predetermined period of time.

Fourth, in the case of considering a latency among QoS parameters of the service flow as the handover completion criterion, the handover management unit 240 may disconnect a connection of a service flow connected via a RAN with the latency by the threshold greater than the RAN with the least latency, or may disconnect a connection of a service flow connected via a RAN with the latency by the threshold greater than the RAN with the least latency for the predetermined period of time.

Fifth, in the case of considering a processing amount among QoS parameters of the flow service as the handover completion criterion, the handover management unit 240 may disconnect a connection of a service flow connected via a RAN that does not satisfy a processing amount required by the service flow for the predetermined period of time.

Sixth, in the case of considering a latency change amount among QoS parameters of the service flow as the handover completion criterion, the handover management unit 240 may disconnect a connection of a service flow connected via a RAN that does not satisfy a latency change amount required by the service flow for a predetermined period of time, or may disconnect a connection of a service flow connected via a RAN with the latency change amount by the threshold greater than a RAN with the least latency change amount, or may disconnect a connection of a service flow connected via a RAN with the latency change amount by the threshold greater than the RAN with the least latency change amount for the predetermined period of time.

Seventh, in the case of considering an error rate among QoS parameters of the service flow as the handover completion criterion, the handover management unit 240 may disconnect a connection of a service flow connected via a RAN that does not satisfy an error rate required by the service flow for a predetermined period of time, or may disconnect a connection of a service flow connected via a RAN with the error rate by the threshold greater than a RAN with the lowest error rate, or may disconnect a connection of a service flow connected via a RAN with the error rate by the threshold greater than the RAN with the lowest error rate for the predetermined period of time.

Eighth, in the case of considering the user's RAN preference as the handover completion criterion, the handover management unit 240 may disconnect a connection of a service flow connected via a RAN with a relatively low RAN preference.

Ninth, in the case of considering the service cost as the handover completion criterion, the handover management unit 240 may disconnect a connection of a service flow connected via a RAN with a relatively high service cost.

Hereinafter, a method of receiving the same application service via multiple RANs when a user terminal performs handover to thereby maintain QoS will be described with reference to the accompanying drawings.

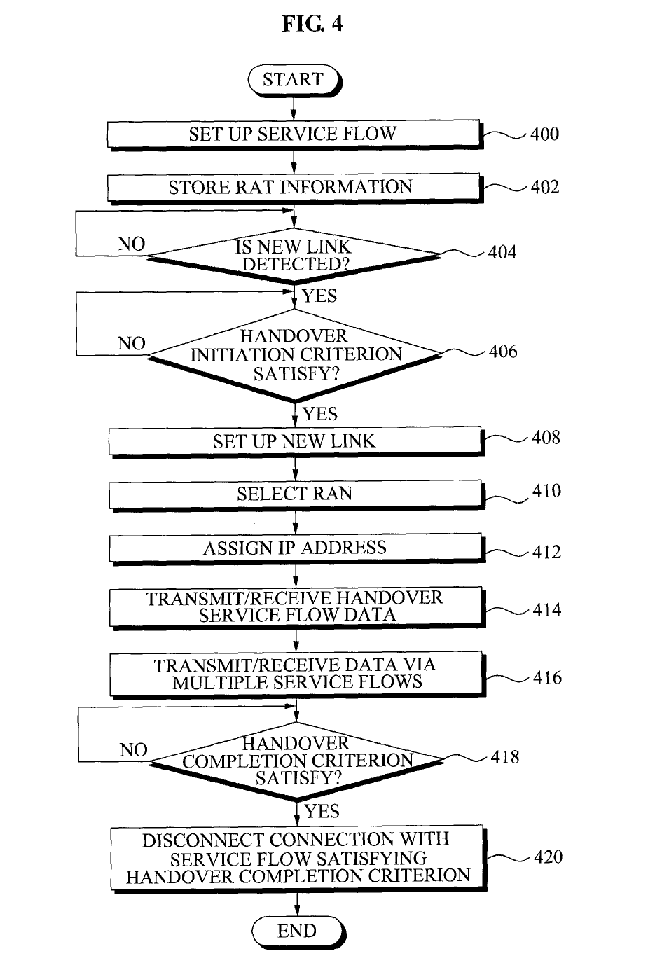

FIG. 4 is a flowchart illustrating a method of maintaining a QoS even when a user terminal performs handover according to an embodiment of the present invention. Referring to FIG. 4, the user terminal may set up a service flow and store the service flow in the QoS management unit 220 in operation 400. In this instance, when using SIP in order to set up the service flow, the user terminal may obtain service flow information from SIP/SDP. Conversely, when not using the SIP, the user terminal may set up the service flow according to a service class and store the service flow. The service class is defined in an application layer protocol used.

In operation 402, the user terminal may store RAT information associated with a connecting RAN. The RAT information may be stored in the information management unit 210 through an information service that is transmitted together with an event service of MIH.

In operation 404, the handover management unit 240 of the user terminal may command the MIH 122 for a periodical or non-periodical search of a new RAT. When the new RAT exists, the handover management unit 240 may store the found RAT as available RAT information.

When the new RAT exists in operation S404, that is, when the new link is detected, the handover management unit 240 of the user terminal may periodically or aperiodically check whether a RAN satisfying a handover initiation criterion exists based on a QoS satisfaction level of a service flow connected via a current RAN, received from the QoS management unit 220, and RAN preference information of a subscriber, received from the information management unit 210, in operation S406. In this instance, a received signal quality of the current RAN, a RAN load, the QoS satisfaction level of the service flow, a user's RAN preference, a service cost, and the like may be considered.

When the RAN satisfying the handover initiation criterion exists in operation 406, the handover management unit 240 of the user terminal may set up a link with the new RAN and store associated RAT information in the information management unit 210 in operation 408. In operation 410, the handover management unit 240 may select a RAN based on a received signal quality of a handover predicted RAN, a RAN load, a user's RAN preference, a service cost, and the like, using RAN preference information and available RAT information stored in the information management unit 210.

In operation 412, the user terminal may be assigned with an IP address to be used in the selected RAN and store associated information in the information management unit 210. In operation 414, the handover management unit 240 may request the sequence management unit 230 to set up a handover service flow using RAT information stored in the information management unit 210. The sequence management unit 230 may set up the handover service flow.

When the handover service flow is completely set up, the user terminal may combine the service flow connected via the existing RAN and a handover service flow transferred via the handover selected RAN in the sequence management unit 230 in operation 416 and transfer the combined service flow to the upper layer and thereby transmit and receive data.

While transmitting and receiving the data via multiple service flows, the handover management unit 240 of the user terminal may verify whether the handover completion criterion is satisfied in operation 418. When the handover completion criterion is not satisfied, the handover management unit 240 may continuously receive the service via the multiple service flows.

Conversely, when the handover completion criterion is satisfied in operation 418, the handover management unit 240 of the user terminal may request the sequence management unit 230 to disconnect a connection of a service flow that is connected via a RAN satisfying the handover completion criterion. When the connection is disconnected, the handover management unit 240 may disconnect the connection with the RAN satisfying the handover completion criterion via the MIH 122.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of providing a seamless service, wherein a user terminal self-directly determines a connection using obtained user preference information.

2. The method of claim 1, wherein the determining of the connection by the user terminal indicates that the user terminal self-directly determines a connection setup of a communication network including a base station, and/or wherein the determining of the connection by the user terminal transmits at least one service flow to thereby determine a connection setup.

3. (canceled)

4. The method of claim 2, wherein the transmitting of the at least one service flow generates at least two service flows transmitting a traffic, and/or wherein the generating of the at least two service flows generates a new service flow transmitting the traffic to a corresponding user terminal within a service delay tolerance limit of at least one service flow.

5. (canceled)

6. The method of claim 1, wherein the user terminal manages available radio access network (RAN) information.

7. The method of claim 6, wherein the managing of the available network information by the user terminal uses RAN preference information when managing the available RAN.

8. The method of claim 7, wherein the using of the RAN preference information uses at least one of a communication cost and a quality of service (QoS).

9. The method of claim 7, wherein the managing of the available RAN information by the user terminal indicates that an end user terminal obtains RAN information via a communication network including a base station to thereby manage the available RAN information.

10. The method of claim 1, wherein an end user terminal determines a candidate connection to transmit at least one service flow.

11. The method of claim 1, wherein the user terminal self-directly determines to perform handover.

12. The method of claim 11, wherein the performing of the handover indicates that an end user terminal self-directly determines a handover initiation, a handover performing RAN selection, and a handover completion.

13. The method of claim 12, wherein the performing of the handover performs the handover using at least one of a signal quality of a currently connecting RAN, an available resource of a network, a packet transmission latency, a change amount in the packet transmission latency, QoS information such as an error rate, a predetermined RAN preference, and a cost.

14. The method of claim 12, wherein the determining of the handover completion by the end user terminal releases a service flow that is set up via an access path satisfying a handover completion criterion.

15. A system for providing a seamless service, wherein a layer for providing a mobility to an upper layer greater than a transport layer exists so that a user terminal self-directly provides the seamless service.

16. The system of claim 15, wherein the layer for providing the mobility further comprises an information management block that manages information of a service flow generated by the user terminal, a handover policy of the user terminal, and a radio access technology (RAT), and/or, wherein the layer for providing the mobility further comprises a QoS management block that manages information associated with wired/radio resources requested to satisfy a QoS of the service flow and a QoS parameter requested by the service flow, and/or, wherein the layer for providing the mobility further comprises a sequence management block that manages information associated with a setup of a handover service flow, a recognition of a multi-path service flow, and a time of a Transmission Control Protocol (TCP)/User Datagram Protocol (UDP) service flow, and/or, wherein the layer for providing mobility further comprises a handover management block that controls a search of a new RAN, a handover initiation, a handover selection RAN decision, and a handover completion.

17. The system of claim 16, wherein the information management block generates information of the service flow based on information that is stored when transmitting a control message of an application layer protocol.

18. The system of claim 16, wherein the handover policy management of the information management block receives, from a user, information associated with the handover policy via a user interface.

19. (canceled)

20. The system of claim 16, wherein the QoS management block calculates a resource required to satisfy the QoS, based on service flow session information defined when setting up the service flow, or the QoS parameter stored according to the application layer protocol

21. (canceled)

22. The system of claim 16, wherein, when a handover selection RAN is selected, the setup of the handover service flow generates the handover service flow via the handover selection connection network.

23. The system of claim 16, wherein the recognition of the multi-path service flow recognizes multiple service flows providing the same service.

24. The system of claim 16, wherein, when combining TCP/UDP service flows, the sequence management block combines the TCP/UDP service flows into a single service flow using sequence information of multiple TCP services flows and packet information.

25. (canceled)
